(19) United States
(12) Patent Application Publication
(10) Pub. No.: US 2006/0200322 A1
(43) Pub. Date: Sep. 7, 2006

(54) Method and device for assisting a user to control a habit related action

(76) Inventors: Steingrimur Th Blondal, Aarhus C (DK); Karsten Pedersen, Silkeborg (DK)

Correspondence Address: PITNEY HARDIN LLP, 7 TIMES SQUARE, NEW YORK, NY, 10036-7311, US

(21) Appl. No.: 10/547,146

(22) PCT Filed: Feb. 25, 2004
(86) PCT No.: PCT/DK04/00124

§ 371 Date: May 10, 2006

(30) Foreign Application Priority Data
Feb. 25, 2003 (DK) BA 2003 00064

(51) Int. Cl. G04F 8/00; G04F 1/00; G04F 3/00; G06F 15/00

(52) U.S. Cl. 702/177

(57) ABSTRACT

The present invention relates to a method of assisting a user to control a habit related action, such as smoking cigarettes, said method assists said user in a predefined control period and said assisting is based on predefined control criteria defined by the user, said predefined control criteria comprising a begin frequency defining the frequency of the habit related actions at the beginning of the predefined control period and a goal frequency defining the frequency of the habit related actions at the end of the predefined control period, said method comprises the steps of:—receiving said predefined control criteria from said user,—determining, based on said predefined control criteria, the allow frequency defining when said habit-related action is allowed in said predefined control period,—indicating to said user when said habit-related action is allowed based on said determined allow frequency. Thereby the method is individually based on the user's control criteria, and can thereby be used by a larger number of people either smokers or users with another habit, which the user wishes to control. The invention also relates to a device (101) adapted to assist a user to control a habit related action.

### FIELD OF THE INVENTION

The present invention relates to a method of assisting a user to control a habit related action, such as smoking cigarettes. The invention further relates to a device adapted to assist a user to control a habit related action.

### BACKGROUND OF THE INVENTION

It is well known that smoking and other habit related actions have caused a big health care problem for most of the countries in the last decades. Many of today's smokers have tried once or more often either to reduce or quit smoking. One of the solutions offered is using nicotine gum, where the user can get the nicotine kick that most smokers are addicted to. The problem with the nicotine gum is that is does not assist people in disposing the nicotine addiction.

Further, an electronic device exists adapted to assist people to quit smoking. Initially the device collects data relating to the number of cigarettes for a predefined time period, where the collected data is indications of when the user is smoking a cigarette by pressing a button on the device. After collecting the data, the device generates a plan where the user is instructed when he is allowed to smoke and when not. The problem with this device is that it uses these data to generate a fixed plan being based on criteria already defined in the device. Thereby all users have the same plan meaning the same time period for mitigating their habit and the same goal. The problem with this is that the device would only function for a small group of people; other people might require a slower mitigation time or another goal in order to obtain success.

Generally, problems that people have to overcome during mitigation of a habit related action, such as smoking, are:
Physical abstinences being discomfort because of the need for nicotine and other chemical drugs in the cigarette.
Psychological need, being the ritual that the smoker has when smoking, e.g. lightning the cigarette after dinner or while turning on the computer or together with other actions during the day.

Further problems are failing motivation, laziness and economy if the mitigation is too demanding for the smoker because of either time, troubles or expenses related to buying habit controlling products, such as gum or bandages.

### OBJECT AND SUMMARY OF THE INVENTION

It is therefore an object of a method of assisting a user to control a habit related action to solve the above mentioned problems.

This is obtained by a method of assisting a user to control a habit related action, such as smoking cigarettes, said method assisting said user in a predefined control period, and said assisting is based on predefined control criteria defined by the user, said predefined control criteria comprising a begin frequency defining the frequency of the habit related actions at the beginning of the predefined control period and a goal frequency defining the frequency of the habit related actions at the end of the predefined control period, said method comprises the steps of:
receiving said predefined control criteria from said user,
determining, based on said predefined control criteria, the allowed frequency defining when said habit-related action is allowed in said predefined control period,
indicating to said user when said habit-related action is allowed based on said determined allowed frequency.

Thereby the method is individually based on the specific user's control criteria and can thereby be used by a larger number of people, either smokers or users with another habit, which the user wishes to control. Further, by letting the individual control criteria be the basis of the assisting, the method will more often result in a success, being that the user reaches the goal within the predefined control period. The habit action could also be using of a drug, eating and other actions that can be addicting.

In an embodiment the method further comprises the step of receiving habit indications from said user each time the user performs the habit related action, and thereby registering said habit related action, and wherein the step of indicating to said user when said habit-related action is allowed is further based on said received habit indications. Thereby it is possible to both indicate when it is allowed and when it is not allowed based on the user.

In an embodiment said start frequency is larger than said goal frequency, and wherein the allowed frequency of the habit-related action is decreased from the start frequency at the beginning of said predefined control period to the goal frequency at the end of said predefined control period. Thereby the method can be used for decreasing or quitting the habit related action.

In a specific embodiment said allow frequency is decreased linearly from the start frequency at the beginning of said predefined control period to the goal frequency at the end of said predefined control period. Thereby the number of allowed habit related actions is decreased in a way more logical to the user, and the goal frequency is not obtained before the last day of the predefined period.

In an embodiment said start frequency equals said goal frequency and wherein the allow frequency of the habit-related action is kept constant in said predefined control period. Thereby the method can be used for maintaining a constant habit related action, e.g. ensuring that the number of cigarettes smoked per day is not increased.

In an embodiment said predefined criteria further comprise a definition of the user's awake time intervals in said predefined control period, and wherein said allow frequency is determined for each awake time interval. Thereby the assisting of the user is only based on awake time, and only performed when the user is actually awake.

In an embodiment said method further comprises determining saved habit related actions by determining, based on said habit indications from said user, when a habit related action is being allowed but not performed by the user, wherein the step of indicating to said user when said habit-related action is allowed is further based on said determined saved habit related action. Thereby the user can save a habit related action for a later time. This has proven to increase the motivation of the user and thereby increase the chances of success by reaching the goal frequency within said predefined time period.

In an embodiment the predefined control criteria further comprise a saving limit defining an allowed maximum of saved habit related actions. This ensures that the user cannot save too many habit related actions, e.g. because of long periods where the user does not feel like smoking, e.g. during sickness.

The invention further relates to a computer readable medium having stored therein instructions for causing a processing unit to execute the method described above.

The invention further relates to a device adapted to assist a user to control a habit related action, such as smoking cigarettes, said device assisting said user in a predefined control period, and said assisting is based on predefined control criteria defined by the user, the predefined control criteria comprise a begin frequency defining the frequency of the habit related actions at the beginning of the predefined control period and a goal frequency defining the frequency of the habit related actions at the end of the predefined control period, wherein said device comprises:
input means for receiving said predefined control criteria from said user,
storing means for storing said received predefined control criteria,
input means for receiving habit indications from said user each time the user performs the habit related action,
processing means for determining, based on said predefined control criteria, the allow frequency defining when said habit related action is allowed in said predefined control period,
indicating to said user when said habit related action is allowed based on said determined allow frequency and said received habit indications.

The device could be a dedicated device, or it could be a device running software enabling it to perform the method according to the invention. The device could e.g. be a mobile phone, a PDA, or a Music player.

In an embodiment the indication means is a display adapted for indicating to the user when said habit related action is allowed.

### BRIEF DESCRIPTION OF THE DRAWINGS

In the following preferred embodiments of the invention will be described referring to figures, where

FIG. 1 shows a device adapted to assist a user to control a habit related action,

FIG. 2 shows a flow diagram of the method of assisting a user to control a habit related action,

FIG. 3 illustrates the method of defining the control criteria in a setup phase,

FIG. 4A, 4B, 4C show the device in a setup phase as discussed in FIG. 3,

FIG. 5 shows different information or statistical information than can be monitored when using the device.

### DESCRIPTION OF PREFERRED EMBODIMENTS

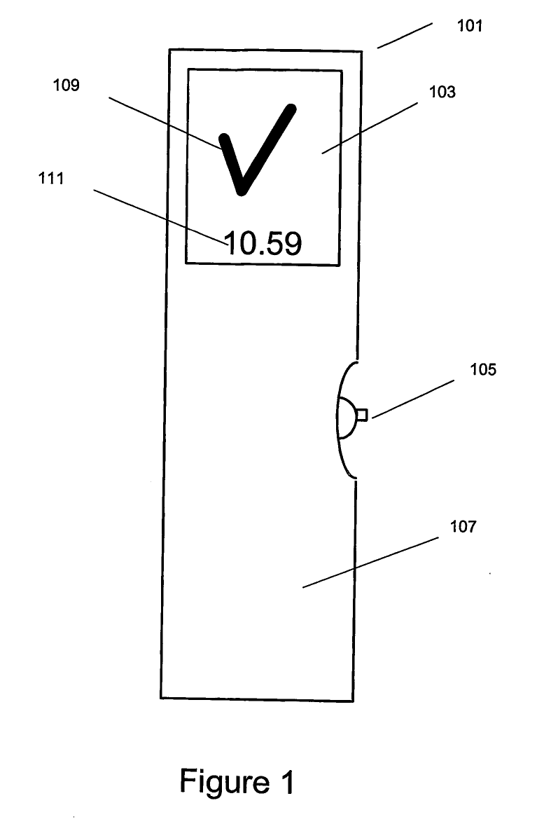

FIG. 1 shows a device 101 adapted to assist a user to control a habit related action, wherein the device comprises a display screen 103, a user button 105 and processing and storage means 107 integrated into the device, which could be a low power microprocessor with integrated storage means.

The device assists said user in a predefined control period to control said habit related action based on predefined control criteria defined by the user. In one example the predefined control criteria comprise the following information:
the control period, i.e. the time until which the user plans to reach the goal of quitting e.g. smoking (or reducing or maintaining a constant level of smoking),
a begin frequency for a predefined time interval, which can be the number of cigarettes smoked by the user per day or alternatively per time period,
the number of habit related actions, which the user wants to be able to save, e.g. the number of cigarettes that the user wants to be able to save, which can be a fixed number or a number indicating a ratio from the number of cigarettes that the user is allowed to smoke per day,
goal frequency defining the frequency of the habit related actions at the end of the predefined control period, e.g. quitting smoking, reducing smoking or maintaining a constant level of smoking, and
a definition of the user's awake time intervals being the time interval where the user does not sleep.

These predefined control criteria are e.g. stored in temporarily storage means, such as RAM, and based thereon the processing and storing means 107 determine when a habit related action is allowed in said control period, wherein this is indicated to the user through the display screen 103. Based on the predefined control criteria an allow frequency defining when a habit related action is allowed in said control period is determined. In one embodiment said habit related action is smoking cigarettes, and said allow frequency is to instruct the user when the user is allowed to smoke a cigarette.

In FIG. 1 the “v” sign 109 means that it is okay to perform a habit related action, e.g. it is allowed to smoke a cigarette. The user can accept this by pressing the user button 105. Based on the allow frequency the user must now wait until the next habit related action is allowed, i.e. until the next cigarette is allowed. During that time the display screen 103 displays a forbidden sign. In one embodiment the display screen 103 is also adapted to display information, such as the clock 111.

By integrating several counters into the device, further information can be monitored, such as the time related to the control period, such as how much time has passed and how much time is left, the number of habit related actions used and being left for a predefined time interval, e.g. the number of cigarettes left for the user to smoke for one day and the number of cigarettes already smoked and the time at which it is allowed to smoke the next cigarette.

In one preferred embodiment a habit related action can be saved for a later time. Using the previous example, where the habit related action is smoking cigarettes, the user can save the cigarettes. As mentioned earlier, one of the pieces of information that the user enters is the maximum number of cigarettes that can be saved on a daily basis. This number can define the ratio from the total number of cigarettes allowed to be smoked per day or a fixed number. As an example of the fixed number, if the total number of cigarettes to be smoked is 20, and the user enters the number 5 in the category for saving cigarettes, then the number of cigarettes that can be saved is 5. Thereby, when the number of cigarettes allowed to be smoked per day decreases, the number of cigarettes allowed to be saved decreases as well. The saved cigarettes can in one embodiment be smoked later that day as the user wishes.

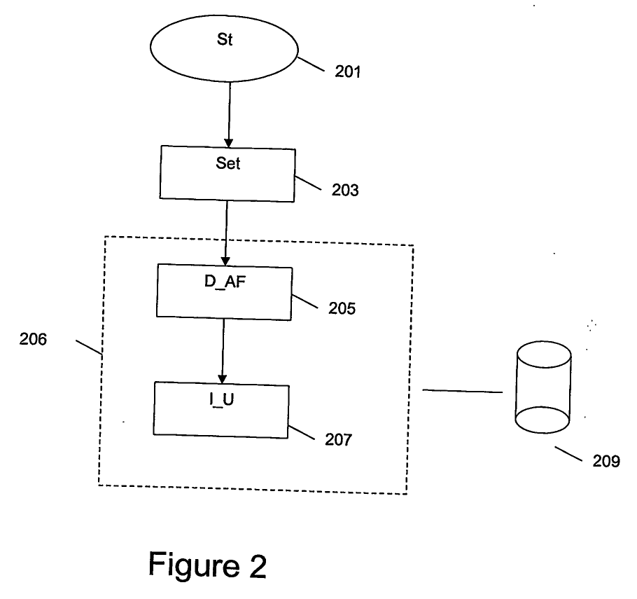

FIG. 2 shows a flow diagram of the method according to the invention from the step where the device is turned on 201 (St) and to the setup followed by 206 assisting the user by indicating when a habit related action is allowed in the predefined control period. After turning the device on, the setup phase 203 (Set) is entered. In this phase the device receives information relating to the predefined control criteria, which are used to determine when a habit related action is allowed.

The information is stored in storage means 209 of the device and used to generate said allow frequency 205 (D_AF), which is adapted to instruct a user 207 (I_U) throughout the control period when a habit related action is forbidden and when a habit related action is allowed. The allow frequency is generated based on the waking time of the user, so that the number of said habit related actions is reduced until the goal frequency is reached. Instructing the user is in one preferred embodiment performed through a display pictogram on the device, which will be discussed in more details later.

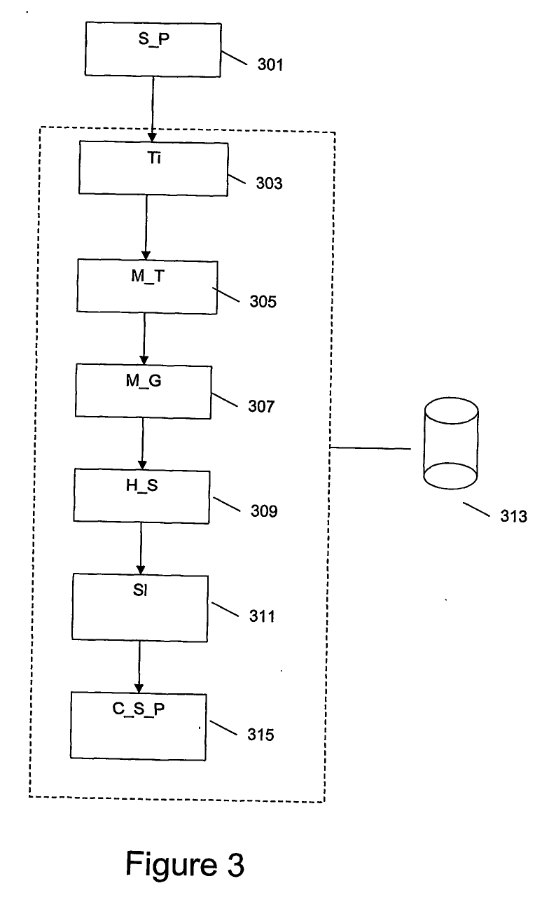

FIG. 3 shows a flow diagram illustrating the setup phase (S_P) 301, wherein the control criteria are defined by the user, said criteria being afterwards used to generate an allow frequency and thereby to indicate to the user when a habit related action is allowed in the predefined control period. In this embodiment this information comprises the actual time (setting up the clock of the device) 303 (Ti), the control period 305 (M_T), i.e. the time until the user plans to reach a goal frequency, the begin frequency and the goal frequency 307 (M_G), which are the frequency of habit related actions at the begin and the end of the predefined control period, the number of habit related actions that can be saved 309 (H_S), which e.g. could be on a daily basis and the time during which the user sleeps 311 (SI). Thereafter the setup phase is closed 315 (C_S_P). All these data are stored in storage means 313 at the device and used to generate said allow frequency. Inherently other information is also possible relating to the control criteria.

In one embodiment the habit related action is smoking, and the goal frequency is to reduce the smoking and ending in some fixed amount of cigarettes per day in order to quit the smoking or to maintain a constant smoking habit. The last example can be adapted to prevent a smoker from increasing the smoking, e.g. to smoke 7 cigarettes a day, nothing more and nothing less. In this same example the control period can be the time until which the user wishes to reach the goal frequency.

Other habit related actions can be using any kinds of habit related materials such as medicine and drugs. Also the habit related action can be related to any kinds of mania such as washing the hands every 10 minutes.

Based on the allow frequency, defining how many habit related actions that can be performed per day, the time intervals between the habit related actions can be determined. If the allow frequency is to be reduced, then the time interval between two habit related actions is increased during the control period. The increase in said time interval is in one preferred embodiment calculated based on a number of habit related actions that are to be reduced for a predefined time interval, e.g. per day.

In one embodiment a counter is used to control the time intervals between two habit related actions. In one embodiment the counter is started when a habit related action is accepted by a user, whereby the counter counts downwards, e.g. from 60 minutes, if the time interval between two habit related actions is 60 minutes. When the time of this counter reaches zero, another habit related action is allowed.

In this example the counter can be updated every one hour by adding said increase in time. As an example the increase can be 1 minute, so that the time between the first two cigarettes is 60 minutes, between the second and third 61 minutes, the third and the fourth 62 minutes etc. When a habit related action is accepted, the counter starts to count down the time until it reaches zero, which indicates that the habit related action is allowed. The device is accordingly adapted to display a “forbidden” sign, when the counter has not reached the zero value, and to display the “okay” sign indicating that a habit related action is allowed, when the counter has reached the zero value. If the habit related action is not accepted the “okay” sign is displayed.

In one preferred embodiment the device comprises an additional counter that counts the time from the time where the previous counter reached the zero value until the habit related action is accepted. The zero value starts this second counter, and by accepting the habit related action, the counter is stopped. This counter is adapted to save habit related actions. As an example, if the habit related action is not accepted by a user for 30 minutes, the second counter stores these 30 minutes, until the next time when the habit related action is not accepted by the user. Using the previous example for cigarettes, the user is instructed that he is allowed to smoke a cigarette, but he does not accept it, then the time from where it was allowed to smoke the cigarette until the user accepted to smoke the cigarette is stored. In that way the counter collects all the times when a habit related action is not accepted. When this collected time corresponds to at least the time between two habit related actions, one habit related action has been saved and is stored for a later time. This can also motivate the user having a habit related action.

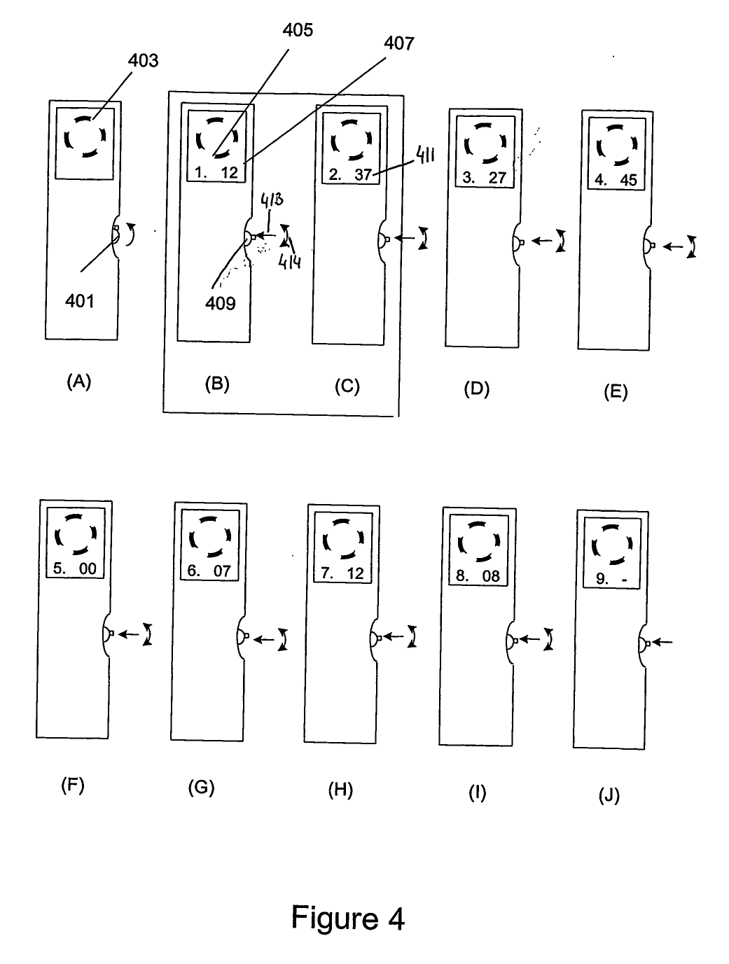

FIGS. 4(A)-(C) show the device in a setup phase as discussed in FIG. 3, where information defining the allow frequency is received. In FIG. 4(A) the setup phase is initiated by pressing the user button upwards 401 and holding the button in that position until the setup sign 403 is shown on the display screen. This setup sign 403 indicates the setup phase of the device. The first step in the setup phase 405 is to enter the actual time (the clock), which is done in the first two steps in FIGS. 4(B) and (C), where the hours 407 and the minutes 411 are entered. To change the hours or minutes, or any of the criteria shown in (B)-(J), the button 409 is pressed as indicated by the arrow 413 and subsequently moved upwards or downwards as indicated by the arrows 414, thereby increasing or decreasing the numbers 407, 411 displayed, i.e. the hours and the minutes. To go out from the second step (FIG. 4(C)) the user button 401 is pressed again, and the user button is moved upwards (or downwards) to go to the third step. In the third step in this setup phase (FIG. 4(D)) the predefined control period is selected, where again the user button 409 is pressed inwards, and subsequently the number of e.g. weeks in the predefined control period is entered by moving the user button either upwards or downwards. In this case using the number of weeks is 27. In the fourth step (E) the begin frequency is entered in the example as 45 cigarettes per day, and in the fifth step the goal frequency is entered (FIG. 4(F)). Here the goal frequency is as an example to smoke no cigarettes after the control period, which is 27 weeks. In the sixth step (FIG. 4(G)) the number or the ratio of saved habit related actions is entered, e.g. entering the number 15 means dividing multiplying the number of cigarettes per day with ⅕ to get the allowed number of saved cigarettes, or the number 5 could be entered as a fixed number, meaning 5 cigarettes is allowed to be saved. Preferably the saved habit related actions are calculated on a daily basis. In steps 7 and 8 (FIG. 4(H) and (I)) the time when the user goes to sleep and the time when the user wakes up are entered. This is to determine the waking time of the user.

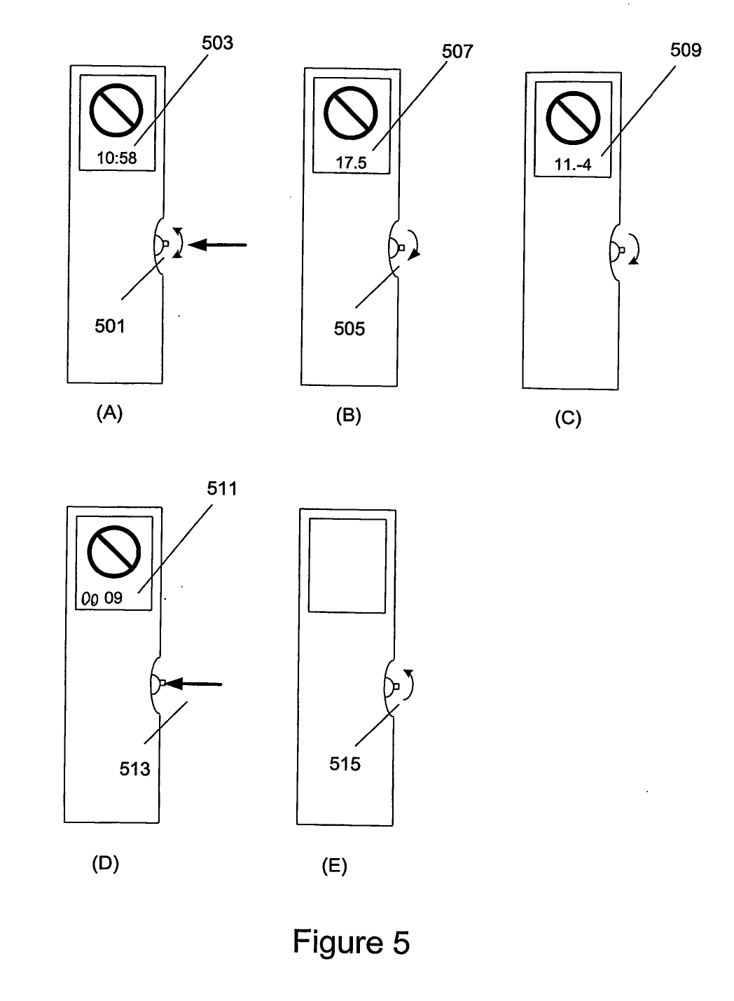

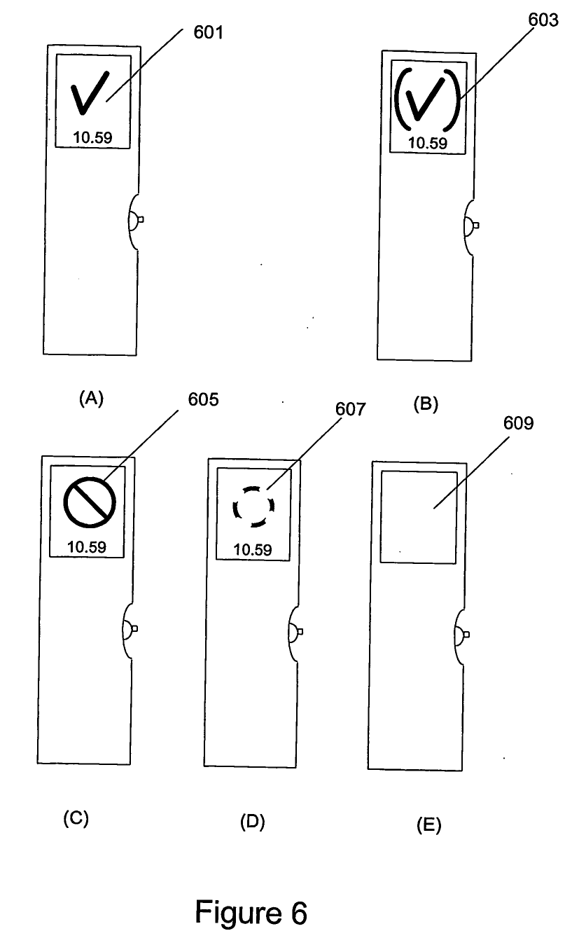

FIG. 5(A)-(F) shows different information or statistical information than can be monitored when using the device through the user button 501. Here the device is in a phase where it instructs the user not to smoke. In FIG. 5(A) the actual time is shown 503. By pressing the user button downwards as shown in FIG. 5(B) 505 the information shows the calculated number of habit related actions that is allowed, e.g. the calculated number of cigarettes that are allowed to smoked per day, which is 17, and the number of cigarettes already smoked that day, which is 5. Also, by pressing the user button downwards (see FIG. 5(C)), information relating to the control period and the time that is passed is displayed. In this case the control period is 11 weeks, and four days have passed. FIG. 5(D) shows that by pressing the user button as indicated by the arrow 513 information is displayed 511 showing the number of hours and minutes until the next habit related action is allowed, i.e. when it is allowed to smoke the next cigarette. FIG. 5(E) shows that by pressing the user button upwards as indicated by the arrow 515, the display is turned off. By pressing the user button again in the same direction, the display screen is turned on again. At least some of this information is preferably only shown during a predefined time interval, such as 1-2 seconds, and subsequently the initial display showing the actual clock is shown.

FIG. 6 shows one embodiment of a functional description to instruct a user by using pictograms, based on a mitigation plan, when a habit related action is allowed and when a habit related action is forbidden. In FIG. 6(A) the sign “v” instructs the user that he is allowed to perform a habit related action. In FIG. 6(B) the device instructs the user by the sign “(v)” 603 that he is allowed to perform a previously saved habit related action(s). In FIG. 6(C) the sign 605 instructs the user that it is forbidden to perform a habit related action, in FIG. 6(D) the sign 607 indicates that the device is in a setup phase, and finally the no sign in FIG. 6(E) indicates that the device has been turned off.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of assisting a user to control a habit related action, such as smoking cigarettes, said method assists said user in a predefined control period, and said assisting is based on predefined control criteria defined by the user, said predefined control criteria comprising a begin frequency defining the frequency of the habit related actions at the beginning of the predefined control period and a goal frequency defining the frequency of the habit related actions at the end of the predefined control period, said method comprises the steps of:
receiving said predefined control criteria from said user,
determining, based on said predefined control criteria, the allow frequency defining when said habit related action is allowed in said predefined control period,
indicating to said user when said habit related action is allowed based on said determined allow frequency.

2. A method according to claim 1, wherein the method further comprises the step of receiving habit indications from said user each time the user performs the habit related action, and thereby registering said habit related action, and wherein the step of indicating to said user when said habit related action is allowed is further based on said received habit indications.

3. A method according to claim 1, wherein said start frequency is larger than said goal frequency, and wherein the allow frequency of the habit related action is decreased from the start frequency at the beginning of said predefined control period to the goal frequency at the end of said predefined control period.

4. A method according to claim 3, wherein said allow frequency is decreased linearly from the start frequency at the beginning of said predefined control period to the goal frequency at the end of said predefined control period.

5. A method according to claim 1, wherein said start frequency equals said goal frequency, and wherein the allow frequency of the habit related action is kept constant in said predefined control period.

6. A method according to claim 1, wherein said predefined criteria further comprise a definition of the user's awake time intervals in said predefined control period, and wherein said allow frequency is determined for each awake time interval.

7. A method according to claim 2, wherein said method further comprises determining saved habit related actions by determining, based on said habit indications from said user, when a habit related actions is being allowed but not performed by the user, wherein the step of indicating to said user when said habit related action is allowed is further based on said determined saved habit related action.

8. A method according to claim 7, wherein the predefined control criteria further comprise a saving limit defining an allowed maximum of saved habit related actions.

9. A computer readable medium having stored therein instructions for causing a processing unit to execute the method of claim 1.

10. A device adapted to assist a user to control a habit related action, such as smoking cigarettes, said device assists said user in a predefined control period and said assisting is based on predefined control criteria defined by the user, where the predefined control criteria comprise a begin frequency defining the frequency of the habit related actions at the beginning of the predefined control period and a goal frequency defining the frequency of the habit related actions at the end of the predefined control period, wherein said device comprises:
input means for receiving said predefined control criteria from said user, said control criteria comprising definition of the user's awake time intervals in said predefined control period.
storing means for storing said received predefined control criteria,
input means for receiving habit indications from said user each time the user performs the habit related action,
processing means for determining, based on said predefined control criteria, the allow frequency defining when said habit related action is allowed in said predefined control period,
an indication means for indicating to said user when said habit related action is allowed based on said determined allow frequency and said received habit indications. wherein said allow frequency is determined for each awake time interval.

11. A device according to claim 10, further comprising means for determining saved habit related action by determining, based on said habit indications from said user, when a habit related action is being allowed but not performed by the user, wherein the step of indicating to said user when said habit related action is allowed is further based on said determined saved habit related action.

12. A method according to claim 11 wherein the predefined control criteria further comprises a saving limit defining an allowed maximum of saved habit related actions.

13. A device according to claim 10 wherein the indication means is a display adapted for indicating to the user when said habit related action is allowed.
